(19) United States
(12) Patent Application Publication
(10) Pub. No.: US 2023/0226533 A1
(43) Pub. Date: Jul. 20, 2023

(54) HYDROCRACKING CATALYST FOR HEAVY DISTILLATE

(71) Applicant: CHEVRON U.S.A. INC., San Ramon, CA (US)

(72) Inventors: Jifei JIA, San Ramon, CA (US); Bi-Zeng ZHAN, San Ramon, CA (US); Theodorus Ludovicus Michael MAESEN, San Ramon, CA (US)

(21) Appl. No.: 18/001,887

(22) PCT Filed: Jun. 15, 2021
(86) PCT No.: PCT/US2021/037389

§ 371 Date: Dec. 15, 2022

Related U.S. Application Data
(60) Provisional application No. 63/040,899, filed on Jun. 18, 2020.

(51) Int. Cl. B01J 29/80; B01J 29/16; B01J 29/78; B01J 21/12; B01J 37/00; B01J 37/02; B01J 37/08; C10G 47/20

(52) U.S. Cl. CPC B01J 29/80; B01J 29/166; B01J 29/7815; B01J 21/12; B01J 37/0018; B01J 37/0203; B01J 37/088; C10G 47/20; B01J 2029/062

(57) ABSTRACT

The process comprises hydrocracking a hydrocarbon feed in a single stage. The catalyst comprises a base impregnated with metals from Group 6 and Groups 8 through 10 of the Periodic Table, as well as citric acid. The base of the catalyst used in the present hydrocracking process comprises alumina, an amorphous silica-alumina (ASA) material, a USY zeolite, and a beta zeolite.

### CROSS REFERENCE TO RELATED APPLICATIONS

This application is the national stage application of International Appl. No. PCT/US21/037389 (doc. no. T-10818), filed on Jun. 15, 2021, and is related to, and claims priority benefit from U.S. Provisional Patent Appl. Ser. No. 63/040,899, filed on Jun. 18, 2020, entitled “HYDROCRACKING CATALYST FOR HEAVY DISTILLATE”, the disclosures of which are herein incorporated by reference in their entirety.

### BACKGROUND

Catalytic hydroprocessing refers to petroleum refining processes in which a carbonaceous feedstock is brought into contact with hydrogen and a catalyst, at a high temperature and pressure, for the purpose of removing undesirable impurities and/or converting the feedstock to an improved product. Examples of hydroprocessing processes include hydrotreating, hydrodemetalization, hydrocracking and hydroisomerization processes.

A hydroprocessing catalyst typically consists of one or more metals deposited on a support or carrier consisting of an amorphous oxide and/or a crystalline microporous material (e.g., a zeolite). The selection of the support and metals depends upon the particular hydroprocessing process for which the catalyst is employed.

Hydrocracking is a catalytic chemical process used in petroleum refineries for converting the high-boiling constituent hydrocarbons in petroleum crude oils to more valuable lower-boiling products such as gasoline, kerosene, jet fuel and diesel oil. The process takes place in a hydrogen-rich atmosphere at elevated temperatures (260-425° C.) and pressures (35-200 bar).

Many current hydrocracking catalysts maximize jet fuel and total middle distillate yields. Hydrocracking catalysts with better heavy distillate selectivity would be well received in the industry.

### SUMMARY

It has been discovered that utilizing the novel catalyst of the present process in a hydrocracking process improves the heavy distillate production. The process comprises hydrocracking a hydrocarbon feed in a single stage. The catalyst used in the single stage of the present hydrocracking process comprises a base impregnated with metals from Group 6 and Groups 8 through 10 of the Periodic Table. The base of the catalyst used in the single hydrocracking stage comprises alumina, an amorphous silica-alumina (ASA) material, a USY zeolite and a beta zeolite. The catalyst also comprises specifically citric acid.

Among other factors, it has been discovered that the use of the present catalyst realizes numerous advantages in a single stage hydrocracking unit. The catalyst system results in improved selectivity for desired heavy distillate products. A synergy between the presence of the metals and citric acid, together with the present base components, has been discovered.

### DESCRIPTION OF PREFERRED EMBODIMENTS

The present process relates to hydrocracking a hydrocarbon feed in a single step. The process is designed to improve the yields and conversion of heavy diesel (boiling point of 530-700° F.). The process employs a particular catalyst comprising a base comprised of alumina, an amorphous silica-aluminate (ASA), a USY zeolite and a beta zeolite. The base is impregnated with catalytic metals selected from Group 6 and Groups 8 through 10 of the Periodic Table, preferably Nickel (Ni) and Tungsten (W), often as salts or oxides. The term “Periodic Table” refers to the version of IUPAC Periodic Table of the Elements dated Jun. 22, 2007, and the numbering scheme for the Periodic Table Groups is as described in Chemical and Engineering News, 63(5), 27 (1985). The base is impregnated with citric acid. The citric acid, in combination with the metals, especially Nickel, and the present base components, has been found to provide an improved selectivity for heavy distillate products (boiling point of 530-700° F.) (277-371° C.).

The base of the catalyst can comprise from about 0.1 to about 40 wt. % alumina base, based on the dry weight of the base, in another embodiment from about 5 to about 40 wt. %, or in another embodiment from about 10 to about 30 wt. % alumina. About 20 wt. % alumina can be used in another embodiment. The base of the catalyst can also comprise from about 20 to about 80 wt. % ASA, based on the dry weight of the base, or in another embodiment from about 20 to about 30 wt. % ASA. The Y zeolite can comprise from 20 to about 60 wt. % of the base based on the dry weight of the base. In another embodiment, the Y zeolite can comprise from about 25 to about 55 wt. %, or in another embodiment, from about 30 to about 50 wt. % of the base. The beta zeolite can comprise from 0.5 to about 40 wt. % of the base based on the dry weight of the base. In another embodiment, the beta zeolite can comprise from about 1 to about 30 wt. %, or in another embodiment, from about 4 to about 20 wt. % of the base.

Overall, the final catalyst composition in one embodiment comprises from 10 to 30 wt. % alumina, or in another embodiment from 10 to 20 wt. % based on the dry weight of the catalyst. In one embodiment, the silica-alumina (ASA) can also be present in an amount from 10 to 30 wt. %, or in another embodiment from 10 to 20 wt. % based on the dry weight of the catalyst. The Y zeolite in one embodiment comprises from 20 to 50 wt. %, or in another embodiment from 30 to 50 wt. % of the catalyst composition based on the dry weight of the catalyst. The beta zeolite, in one embodiment, can comprise from 5 to 20 wt. %, or in another embodiment from 5 to 10 wt. % of the catalyst composition, based on the dry weight of the catalyst.

The alumina can be any alumina known for use in a catalyst base. For example, the alumina can be γ-alumina, η-alumina, θ-alumina, δ-alumina, χ-alumina, or a mixture thereof.

The ASA of the catalyst support is an amorphous silica-alumina material in which the mean mesopore diameter is generally between 70 Å and 130 Å.

In one embodiment, the amorphous silica-alumina material comprises SiO₂ in an amount of 10 to 70 wt. % of the bulk dry weight of the carrier as determined by ICP elemental analysis, a BET surface area of between 450 and 550 m²/g and a total pore volume of between 0.75 and 1.15 mL/g.

In another embodiment, the catalyst support is an amorphous silica-alumina material containing SiO₂ in an amount of 10 to 70 wt. % of the bulk dry weight of the carrier as determined by ICP elemental analysis, a BET surface area of between 450 and 550 m2/g, a total pore volume of between 0.75 and 1.15 mL/g, and a mean mesopore diameter is between 70 Å and 130 Å.

In another subembodiment, the catalyst support is a highly homogeneous amorphous silica-alumina material having a surface to bulk silica to alumina ratio (S/B ratio) of 0.7 to 1.3, and a crystalline alumina phase present in an amount no more than about 10 wt. %.

$$S / B Ratio = \frac{( Si / Al atomic ratio of the surface measured by XPS )}{( Si / Al atomic ratio of the bulk measured by elemental analysis )}$$

To determine the S/B ratio, the Si/AI atomic ratio of the silica-alumina surface is measured using x-ray photoelectron spectroscopy (XPS). XPS is also known as electron spectroscopy for chemical analysis (ESCA). Since the penetration depth of XPS is less than 50 Å, the Si/AI atomic ratio measured by XPS is for the surface chemical composition.

Use of XPS for silica-alumina characterization was published by W. Daneiell et al. in Applied Catalysis A, 196, 247-260, 2000. The XPS technique is, therefore, effective in measuring the chemical composition of the outer layer of catalytic particle surface. Other surface measurement techniques, such as Auger electron spectroscopy (AES) and Secondary-ion mass spectroscopy (SIMS), could also be used for measurement of the surface composition.

Separately, the bulk Si/Al ratio of the composition is determined from ICP elemental analysis. Then, by comparing the surface Si/Al ratio to the bulk Si/Al ratio, the S/B ratio and the homogeneity of silica-alumina are determined. How the S/B ratio defines the homogeneity of a particle is explained as follows. An S/B ratio of 1.0 means the material is completely homogeneous throughout the particles. An S/B ratio of less than 1.0 means the particle surface is enriched with aluminum (or depleted with silicon), and aluminum is predominantly located on the external surface of the particles. The S/B ratio of more than 1.0 means the particle surface is enriched with silicon (or depleted with aluminum), and aluminum is predominantly located on the internal area of the particles.

“Zeolite USY” refers to ultra-stabilized Y zeolite. Y zeolites are synthetic faujasite (FAU) zeolites having a SAR of 3 or higher. Y zeolite can be ultra-stabilized by one or more of hydrothermal stabilization, dealumination, and isomorphous substitution. Zeolite USY can be any FAU-type zeolite with a higher framework silicon content than a starting (as-synthesized) N-Y zeolite precursor. Such suitable Y zeolites are commercially available from, e.g., Zeolyst International, Tosoh Corporation, and JGC Catalyst and Chemicals Ltd. (JGC CC).

The zeolite beta refers to zeolites having a 3-dimensional crystal structure with straight 12-membered ring channels with crossed 12-membered ring channels, and having a framework density of about 15.3 T/1000 Å³. Zeolite beta has a BEA framework as described in Ch. Baerlocher and L. B. McCusker, Database of Zeolite Structures: http://www.iza-structure.org/databases/.

In one embodiment, the zeolite beta has an OD acidity of 20 to 400 μmol/g and an average domain size from 800 to 1500 nm². In one embodiment, the OD acidity is from 30 to 100 μmol/g.

In one embodiment the zeolite beta is synthetically manufactured using organic templates. Examples of three different zeolite betas are described in Table 1.

TABLE 1

| | SiO₂/Al₂O₃ Molar Ratio | OD Acidity |
|---|---|---|
| Zeolite Beta | (SAR) | μmol/g |
| H-BEA-35 | 35 | 304 |
| H-BEA-150 | 150 | 36 |
| H-BEA-300 | 300 | Not measured |

The total OD acidity was determined by H/D exchange of acidic hydroxyl groups by FTIR spectroscopy. The method to determine the total OD acidity was adapted from the method described in the publication by Emiel J. M. Hensen et. al., J. Phys. Chem., C2010, 114, 8363-8374. Prior to FTIR measurement, the sample was heated for one hour at 400-450° C. under vacuum <1×10⁻⁵ Torr. Then the sample was dosed with C₆D₆ to equilibrium at 80° C. Before and after C₆D₆ dosing, spectra were collected for OH and OD stretching regions.

The average domain size was determined by a combination of transmission electron (TEM) and digital image analysis, as follows:

### I. Zeolite Beta Sample Preparation:

The zeolite beta sample was prepared by embedding a small amount of the zeolite beta in an epoxy and microtoming. The description of suitable procedures can be found in many standard microscopy text books.

Step 1. A small representative portion of the zeolite beta powder was embedded in epoxy. The epoxy was allowed to cure.

Step 2. The epoxy containing a representative portion of the zeolite beta powder was microtomed to 80-90 nm thick. The microtome sections were collected on a 400 mesh 3 mm copper grid, available from microscopy supply vendors.

Step 3. A sufficient layer of electrically-conducting carbon was vacuum evaporated onto the microtomed sections to prevent the zeolite beta sample from charging under the electron beam in the TEM.

### II. Tem Imaging:

Step 1. The prepared zeolite beta sample, described above, was surveyed at low magnifications, e.g., 250,000-1,000,000× to select a crystal in which the zeolite beta channels can be viewed.

Step 2. The selected zeolite beta crystals were tilted onto their zone axis, focused to near Scherzer defocus, and an image was recorded ≥2,000,000×.

III. Image Analysis to Obtain Average Domain Size (nm²):

Step 1. The recorded TEM digital images described previously were analyzed using commercially available image analysis software packages.

Step 2. The individual domains were isolated and the domain sizes were measured in nm². The domains where the projection was not clearly down the channel view were not included in the measurements.

Step 3. A statistically relevant number of domains were measured. The raw data was stored in a computer spreadsheet program.

Step 4. Descriptive statistics, and frequencies were determined. The arithmetic mean (dₐᵥ), or average domain size, and the standard deviation (s) were calculated using the following equations:

The average domain size,dₐᵥ=(ånᵢdᵢ)/(ånᵢ)

The standard deviation,s=(å(dᵢ−dₐᵥ)²/(ånᵢ))^{1/2}

In one embodiment the average domain size is from 900 to 1250 nm², such as from 1000 to 1150 nm².

As described herein above, the hydrocracking catalyst of the present process contains one or more metals, which metals are impregnated into the above described base or support. For each embodiment described herein, each metal employed is selected from the group consisting of elements from Group 6 and Groups 8 through 10 of the Periodic Table, and mixtures thereof. In one embodiment, each metal is selected from the group consisting of nickel (Ni), palladium (Pd), platinum (Pt), cobalt (Co), iron (Fe), chromium (Cr), molybdenum (Mo), tungsten (W), and mixtures thereof. In another embodiment, the hydrocracking catalyst contains at least one Group 6 metal and at least one metal selected from Groups 8 through 10 of the periodic table. Exemplary metal combinations include Ni/Mo/W, Ni/Mo, Ni/W, Co/Mo, Co/W, Co/W/Mo and Ni/Co/W/Mo.

The total amount of metal salt material in the hydrocracking catalyst is from 0.1 wt. % to 90 wt. % based on the bulk dry weight of the hydrocracking catalyst. In one embodiment, the hydrocracking catalyst contains from 2 wt. % to 10 wt. % of nickel salt and from 8 wt. % to 40 wt. % of tungsten salt based on the bulk dry weight of the hydrocracking catalyst.

A diluent may be employed in the formation of the hydrocracking catalyst. Suitable diluents include inorganic oxides such as aluminum oxide and silicon oxide, titanium oxide, clays, ceria, and zirconia, and mixture of thereof. The amount of diluent in the hydrocracking catalyst is from 0 wt. % to 35 wt. % based on the bulk dry weight of the hydrocracking catalyst. In one embodiment, the amount of diluent in the hydrocracking catalyst is from 0.1 wt. % to 25 wt. % based on the bulk dry weight of the hydrocracking catalyst.

The hydrocracking catalyst of the present process can also contain one or more promoters selected from the group consisting of phosphorous (P), boron (B), fluorine (F), silicon (Si), aluminum (Al), zinc (Zn), manganese (Mn), and mixtures thereof. The amount of promoter in the hydrocracking catalyst is from 0 wt. % to 10 wt. % based on the bulk dry weight of the hydrocracking catalyst. In one embodiment, the amount of promoter in the hydrocracking catalyst is from 0.1 wt. % to 5 wt. % based on the bulk dry weight of the hydrocracking catalyst.

### Preparation of the Hydrocracking Catalyst

In one embodiment, metal deposition is achieved by contacting at least the catalyst support with an impregnation solution. The impregnation solution contains at least one metal salt such as a metal nitrate or metal carbonate, solvent and has a pH between 1 and 5.5, inclusive (1≤pH≤5.5). Most importantly, the impregnation solution further contains citric acid. In one embodiment, a shaped hydrocracking catalyst is prepared by:
(a) forming an extrudable mass containing a catalyst base comprised of alumina, an amorphous silica alumina (ASA), a USY zeolite and a beta zeolite,
(b) extruding the mass to form a shaped extrudate,
(c) calcining the mass to form a calcined extrudate,
(d) contacting the shaped extrudate with an impregnation solution containing at least one metal salt, solvent, citric add, and having a pH between 1 and 5.5, inclusive (1≤pH≤5.5), and
(e) drying the impregnated extrudate at a temperature sufficient to remove the impregnation solution solvent, to form a dried impregnated extrudate.

In another embodiment, a shaped hydrocracking catalyst is prepared by:
(a) forming an extrudable mass containing a catalyst base comprised of alumina, an amorphous silica alumina (ASA), a USY zeolite, and a beta zeolite,
(b) extruding the mass to form a shaped extrudate,
(c) calcining the mass to form a calcined extrudate,
(d) contacting the shaped extrudate with an impregnation solution containing at least one metal salt, solvent, and citric add, wherein the impregnation solution has a pH between 1 and 5.5, inclusive (1≤pH≤5.5), and
(e) drying the impregnated extrudate at a temperature below the decomposition temperature of the citric add but sufficient to remove the impregnation solution, solvent and form a dried impregnated extrudate.

In another embodiment, a shaped hydrocracking catalyst is prepared by:
(a) forming an extrudable mass containing a catalyst base comprised of alumina, an amorphous silica alumina (ASA), a USY zeolite, and a beta zeolite,
(b) extruding the mass to forma shaped extrudate,
(c) calcining the mass to form a calcined extrudate,
(d) contacting the shaped extrudate with an impregnation solution containing at least one metal salt, solvent, and citric add, wherein the impregnation solution has a pH between 1 and 5.5, inclusive (1≤pH≤5.5),
(e) drying the impregnated extrudate at a temperature below the decomposition temperature of the citric add but sufficient to remove the impregnation solution solvent, and form a dried impregnated extrudate, and
(f) calcining the dried impregnated extrudate sufficiently to convert at least one metal into oxide.

In one embodiment, a mild acid is used in forming the extrudable mass containing the catalyst base. For example, in one embodiment a diluted HNO₃ acid aqueous solution from 0.5 to 5 wt. % HNO₃ is used.

In one embodiment, the impregnation solution comprises a metal carbonate. Nickel carbonate in the preferred metal carbonate for use in the preparation of the present catalyst.

The diluent, promoter and/or molecular sieve (if employed) may be combined with the carrier when forming the extrudable mass. In another embodiment, the carrier and (optionally) the diluent, promoter and/or molecular sieve can be impregnated before or after being formed into the desired shapes.

For each embodiment described herein, the impregnation solution has a pH between 1 and 5.5, inclusive (1≤pH≤5.5). In one embodiment, the impregnation solution has a pH between 1.5 and 3.5, inclusive (1.5≤pH≤3.5).

The impregnation solution must also comprise citric acid. The presence of citric acid, in combination with the metals and base components, has been found to provide a favored selectivity for heavy distillate products. For each embodiment described herein, the amount of citric acid in the pre-calcined hydrocracking catalyst is from 2 wt. % to 18 wt. % based on the bulk dry weight of the hydrocracking catalyst.

Depending on the metal salts, citric acid, and other components used to form the impregnation solution, before the addition of a basic component the pH of the impregnation solution will typically have a pH of less than 1, and more typically a pH of about 0.5. By adding a basic component to the impregnation solution to affect a pH adjustment to 1 and 5.5, inclusive (1≤pH≤5.5), the acid concentration is eliminated or reduced to a level which, during calcination, does not acid-catalyze decomposition of the ammonium nitrate at a rate rapid enough to have a deleterious effect on the hydrocracking catalyst. In one embodiment, the acid concentration is eliminated or reduced to a level which, during calcination, does not acid-catalyze decomposition of the ammonium nitrate at a rate rapid enough to have a deleterious effect on more than 10 wt. % of the bulk dry weight of the hydrocracking catalyst (e.g., does not produce fines or fractured extrudates which account for more than 10 wt. % of the bulk dry weight of the post-calcined hydrocracking catalyst),

The basic component can be any base which can dissolve in the solvent selected for the impregnation solution and which is not substantially deleterious to the formation of the catalyst or to the hydrocracking performance of the catalyst, meaning that the base has less than a measureable effect on, or confer less than a material disadvantage to, the performance of the hydrocracking catalyst. A base which is not substantially deleterious to the formation of the catalyst will not reduce catalyst activity by more than 10° F. (5.5° C.) based on the performance of the hydrocracking catalyst without pH correction.

Where the hydrocracking catalyst is to be used in the present hydrocracking process, one suitable base is ammonium hydroxide. Other exemplary bases include potassium hydroxide, sodium hydroxide, calcium hydroxide, and magnesium hydroxide.

The calcination of the extruded mass can vary. Typically, the extruded mass can be calcined at a temperature between 752° F. (400° C.) and 1200° F. (650° C.) for a period of between 1 and 3 hours.

Non-limiting examples of suitable solvents include water and C₁ to C₃ alcohols. Other suitable solvents can include polar solvents such as alcohols, ethers, and amines. Water is a preferred solvent. It is also preferred that the metal compounds be water soluble and that a solution of each be formed, or a single solution containing both metals be formed. The modifying agent can be prepared in a suitable solvent, preferably water.

The three solvent components can be mixed in any sequence. That is, all three can be blended together at the same time, or they can be sequentially mixed in any order. In an embodiment, it is preferred to first mix the one or more metal components in an aqueous media, then add the modifying agent.

The amount of metal precursors and citric acid in the impregnation solution should be selected to achieve preferred ratios of metal to citric acid in the catalyst precursor after drying.

The calcined extrudate is exposed to the impregnation solution until incipient wetness is achieved, typically for a period of between 0.1 and 100 hours (more typically between 1 and 5 hours) at room temperature to 212° F. (100° C.) while tumbling the extrudates, following by aging for from 0.1 to 10 hours, typically from about 0.5 to about 5 hours.

The drying step is conducted at a temperature sufficient to remove the impregnation solution solvent, but below the decomposition temperature of the modifying agent. In another embodiment, the dried impregnated extrudate is then calcined at a temperature above the decomposition temperature of the modifying agent, typically from about 500° F. (260° C.) to 1100° F. (590° C.), for an effective amount of time. The present invention contemplates that when the impregnated extrudate is to be calcined, it will undergo drying during the period where the temperature is being elevated or ramped to the intended calcination temperature. This effective amount of time will range from about 0.5 to about 24 hours, typically from about 1 to about 5 hours. The calcination can be carried out in the presence of a flowing oxygen-containing gas such as air, a flowing inert gas such as nitrogen, or a combination of oxygen-containing and inert gases.

In one embodiment, the impregnated extrudate is calcined at a temperature which does not convert the metals to metal oxides. Yet in another embodiment, the impregnated extrudates can be calcined at a temperature sufficient to convert the metals to metal oxides.

The dried and calcined hydrocracking catalysts of the present invention can be sulfided to form an active catalyst. Sulfiding of the catalyst precursor to form the catalyst can be performed prior to introduction of the catalyst into a reactor (thus ex-situ presulfiding), or can be carried out in the reactor (in-situ sulfiding).

Suitable sulfiding agents include elemental sulfur, ammonium sulfide, ammonium polysulfide ([(NH₄)₂Sₓ), ammonium thiosulfate ((NH₄)₂S₂O₃), sodium thiosulfate (Na₂S₂O₃), thiourea CSN₂H₄, carbon disulfide, dimethyl disulfide (DMDS), dimethyl sulfide (DMS), dibutyl polysulfide (DBPS), mercaptanes, tertiarybutyl polysulfide (PSTB), tertiarynonyl polysulfide (PSTN), aqueous ammonium sulfide.

Generally, the sulfiding agent is present in an amount in excess of the stoichiometric amount required to form the sulfided catalyst. In another embodiment, the amount of sulfiding agent represents a sulphur to metal mole ratio of at least 3 to 1 to produce a sulfided catalyst.

The catalyst is converted into an active sulfided catalyst upon contact with the sulfiding agent at a temperature of 150° F. to 900° F. (66° C. to 482° C.), from 10 minutes to 15 days, and under a H₂-containing gas pressure of 101 kPa to 25,000 kPa. If the sulfidation temperature is below the boiling point of the sulfiding agent, the process is generally carried out at atmospheric pressure. Above the boiling temperature of the sulfiding agent/optional components, the reaction is generally carried out at an increased pressure. As used herein, completion of the sulfidation process means that at least 95% of stoichiometric sulfur quantity necessary to convert the metals into for example, CO₉S₈, MoS₂, WS₂, Ni₃S₂, etc., has been consumed.

In one embodiment, the sulfiding can be carried out to completion in the gaseous phase with hydrogen and a sulfur-containing compound which is decomposable into H₂S. Examples include mercaptanes, CS₂, thiophenes, DMS, DMDS and suitable S-containing refinery outlet gasses. The gaseous mixture of H₂ and sulfur containing compound can be the same or different in the steps. The sulfidation in the gaseous phase can be done in any suitable manner, including a fixed bed process and a moving bed process (in which the catalyst moves relative to the reactor, e.g., ebullated process and rotary furnace).

The contacting between the catalyst precursor with hydrogen and a sulfur-containing compound can be done in one step at a temperature of 68° F. to 700° F. (20° C. to 371° C.) at a pressure of 101 kPa to 25,000 kPa for a period of 1 to 100 hrs. Typically, sulfidation is carried out over a period of time with the temperature being increased or ramped in increments and held over a period of time until completion.

In another embodiment of sulfidation, it can occur in the gaseous phase. The sulfidation is done in two or more steps, with the first step being at a lower temperature than the subsequent step(s).

In one embodiment, the sulfidation is carried out in the liquid phase. At first, the catalyst precursor is brought in contact with an organic liquid in an amount in the range of 20% to 500% of the catalyst total pore volume. The contacting with the organic liquid can be at a temperature ranging from ambient to 248° F. (120° C.). After the incorporation of an organic liquid, the catalyst precursor is brought into contact with hydrogen and a sulfur-containing compound.

In one embodiment, the organic liquid has a boiling range of 200° F. to 1200° F. (93° C. to 649° C.). Exemplary organic liquids include petroleum fractions such as heavy oils, lubricating oil fractions like mineral lube oil, atmospheric gas oils, vacuum gas oils, straight run gas oils, white spirit, middle distillates like diesel, jet fuel and heating oil, naphthas, and gasoline. In one embodiment, the organic liquid contains less than 10 wt. % sulfur, and preferably less than 5 wt. %.

The present process is a single stage hydrocracking process. The hydrocracking process comprises contacting a hydrocarbon feedstock with the present catalyst under hydrocracking conditions to produce an effluent that comprises heavy (530° F.-700° F.) distillates in a single stage. In one embodiment, the catalyst is employed in one or more fixed beds in a single stage hydrocracking unit, with recycle or without recycle (once through). Optionally, the single-stage hydrocracking unit may employ multiple single-stage units operated in parallel.

Suitable hydrocarbon feedstocks include visbroken gas oils (VGB), heavy coker gas oils, gas oils derived from residue hydrocracking or residue desulfurization. Other thermally cracked oils, deasphalted oils, Fischer-Tropsch derived feedstocks, cycle oils from an FCC unit, heavy coal-derived distillates, coal gasification byproduct tars, heavy shale-derived oils, organic waste oils such as those from pulp or paper mills or from waste biomass pyrolysis units.

The hydrocracking conditions include a temperature in the range of from 175° C. to 485° C., molar ratios of hydrogen to hydrocarbon charge from 1 to 100, a pressure in the range of from 0.5 to 350 bar, and a liquid hourly space velocity (LHSV) in the range of from 0.1 to 30. By using the present catalyst base in a single stage hydrocracking process, it has been found that an improvement in more desirable heavy distillate (530-700° F.; 277-371° C.) products are observed. A selectivity is observed which provides a yield greater than 16 wt. % based on the weight of the product at about 55 wt. % synthetic hydrocracking conversion to less than 700° F. (371° C.). In another embodiment, the yield is greater than 16.5 wt. %. In one embodiment, the yield is from about 16 to about 20 wt. %. The yield is at least 16% greater at about 55 wt. % conversion compared to the comparative catalyst Sample A prepared without the use of zeolite beta and citric acid. An overall enhanced amount of distillates boiling in the range 380-700° F. (193-371° C.) and also in the range of 300-700° F. (149-371° C.) is also achieved. In the range of from 380-700° F. (193-371° C.), the yield can be at least 32.5 wt. %, and in one embodiment from 32.5-36 wt. %, at 55 wt. % conversion. The enhanced yield is at least 2% greater in comparison at about 55 wt. % conversion.

### EXAMPLES

### Example 1: Catalyst (Sample) A—Comparative Hydrocracking Catalyst

A comparable hydrocracking catalyst was prepared per the following procedure: 21.0 parts by weight silica-alumina powder (obtained from Sasol), 23.0 parts by weight pseudo boehmite alumina powder (obtained from Sasol), 56.0 parts by weight of zeolite Y (from Zeolyst, JGC CC, Tosoh) were mixed well. A diluted HNO₃ acid aqueous solution (3 wt. %) was added to the mix powder to form an extrudable paste. The paste was extruded in 1/16″ asymmetric quadrilobe shape, and dried at 250° F. (121° C.) overnight. The dried extrudates were calcined at 1100° F. (593° C.) for 1 hour with purging excess dry air, and cooled down to room temperature.

Impregnation of Ni and W was done using a solution containing ammonium metatungstate hydrate (AMT) and nickel nitrate hexahydrate to the target metal loadings of 4.0 wt. % NiO and 25.1 wt. % WO₃ in bulk dry weight of the finished catalyst. The catalyst was dried at 212° F. (100° C.) for 2 h and calcined at 950° F. (510° C.) for 1 h. This catalyst is named Catalyst A and its physical properties are summarized in Table 2 below.

### Example 2: Samples B and C Synthesis

Two hydrocracking catalyst samples (Sample B and Sample C) were synthesized as follows:

Catalyst base synthesis, the two Samples B and C share the same base prepared as follows:

Mix the powders of 21.0 part (dry basis) silica-alumina powder (obtained from Sasol), 23.0 parts (dry basis) pseudo boehmite alumina powder (obtained from Sasol), 45.0 parts by weight (dry basis) of zeolite Y (from Zeolyst, JGC CC, Tosoh), and 11.0 part of zeolite beta (obtained from Clariant, China Catalyst Group, Zeolyst) with diluted HNO₃ to get a mixture with 53 wt. % volatiles and 3 wt. % HNO₃ (total dry base weight is used for calculation). Then the mixture was extruded in 1/16″ cylinder (L) shape, and dried at 250° F. (121° C.) overnight. The dried extrudates were calcined at 1100° F. (593° C.) for 1 hour with purging excess dry air, and cooled down to room temperature.

Sample B synthesis with impregnation of metals and citric acid: A solution was made at 50° C. that contains 30 g citric acid, 17.5 g nickel carbonate (51 wt. % NiO), and 58.8 g ATM with a volume that equals the water-pore volume of 150 g of the above catalyst base. The metal solution was then impregnated into 150 g (dry basis) of the above catalyst base at 122° F. (50° C.) for 1 h. Then the catalyst was dried at 212° F. (100° C.) for 2 h.

Sample C synthesis with impregnation of metals but no citric acid: A solution was made at room temperature that contains 38.8 g nickel nitrate hexahydrate, and 58.8 g ATM with a volume that equals the water-pore volume of 150 g of the above catalyst base. The metal solution was then impregnated into 150 g (dry basis) of the above catalyst base at room temperature for 1 h. The catalyst was dried at 212° F. (100° C.) for 2 h and calcined at 950° F. (510° C.) for 1 h.

The physical properties and chemical composition of the two samples are listed in Table 2, along with Sample A. They are similar to each other but Sample B's pore volume is smaller than that of Sample C.

TABLE 2
The physical properties and catalyst composition of three samples.

| | | | |
|---|---|---|---|
| | | Sample B | Sample C |
| Catalyst | Sample A | Citric NiW | Non Citric NiW |

Base description

| | | | |
|---|---|---|---|
| BET SSA, m2/g | 367 | 367 | 368 |
| N₂ PV, cc/g | 0.38 | 0.36 | 0.40 |

Catalyst composition wt %

| | | | |
|---|---|---|---|
| Alumina | 15.0 | 15.0 | 15.0 |
| Silica Alumina | 16.0 | 16.0 | 16.0 |
| Zeolite Y | 39.8 | 31.9 | 31.9 |
| Zeolite Beta | 0 | 7.9 | 7.9 |
| NiO | 4.0 | 4.0 | 4.0 |
| WO₃ | 25.1 | 25.1 | 25.1 |

### Example 3: Hydrocracking Test

All three samples were tested under the same test protocol (50/50 vol % ICR 511/catalyst sample, straight run VGO feed, 2300 psig total pressure, 6000 SCFB H₂ rate). The concentration of nitrogen in the effluent liquid after the hydrocracking pretreat catalyst ICR 511 was controlled at about 20 ppm.

The properties of the straight run VGO feedstock are summarized in Table 3:

TABLE 3
Properties of the straight run VGO feed.

| | |
|---|---|
| API | 21.7 |
| Nitrogen, PPM | 997 |
| Sulfur, wt. % | 2.21 |
| PCI by UV, A/G/CC | 2284 |
| MCRT, wt. % | 0.32 |
| Asphaltenes, ppm | 137 |
| Hydrogen by NMR, wt. % | 12.27 |

Hydrocarbon type by MS, Vol %

| | |
|---|---|
| Paraffins | 14.9 |
| Naphthenes | 29.0 |
| Aromatics | 35.3 |
| Sulfur compounds | 20.0 |

SimDist. Wt. %, ° F.

| | |
|---|---|
| IBP | 626 |
| 5% | 689 |
| 10% | 723 |
| 15% | 745 |
| 20% | 762 |
| 30% | 792 |
| 40% | 818 |
| 50% | 842 |
| 60% | 869 |
| 70% | 896 |
| 80% | 930 |
| 90% | 974 |
| 95% | 1010 |
| EP | 1089 |

The testing results are summarized in Table 4.

It is clear that beta zeolite with citric acid helps improve the yields of heavy distillate (530-700° F.), as well as the total distillate (300-700° F.). The synergistic effect of the addition of citric acid into the beta contained catalyst system particularly improves the selectivity to heavy distillate (530-700° F.).

TABLE 4
The product yield comparison at 55 wt. % conversion.

| | | Sample C | |
|---|---|---|---|
| | Sample B | Non Citric | |
| Catalyst | Citric NiW | NiW | Sample A |
| R1 Catalyst Temp., ° F. | 715 | 715 | 715 |
| R2 Catalyst Temp., ° F. | 705 | 710 | 705 |
| LHSV R1/R2, h⁻¹ | 2.0/2.0 | 2.0/2.0 | 2.0/2.0 |
| Total Pressure, psig | 2315 | 2320 | 2298 |
| Inlet H₂ Pressure, psia | 2214 | 2219 | 2198 |
| Hydrogen to oil | 5880 | 5881 | 5883 |
| ratio, SCFB | | | |
| Synthetic Hydrocracking | 56.08 | 55.94 | 55.91 |
| Conversion (<700° F.), Wt % | | | |

No Loss Yields, wt. %

| | | | |
|---|---|---|---|
| Methane | 0.08 | 0.07 | 0.08 |
| Ethane | 0.10 | 0.09 | 0.11 |
| Propane | 0.44 | 0.44 | 0.48 |
| i-Butane | 0.98 | 1.00 | 0.96 |
| n-Butane | 0.58 | 0.61 | 0.57 |
| C5-180° F. | 3.83 | 4.06 | 4.45 |
| 180-300° F. (82-149° C.) | 11.00 | 11.33 | 11.88 |
| 300-380° F. (149-193° C.) | 8.54 | 8.56 | 8.82 |
| 380-530° F. (193-277° C.) | 16.08 | 16.57 | 16.41 |
| 530-700° F. (277-371° C.) | 16.89 | 15.57 | 14.52 |
| 700° F.+ | 41.02 | 41.25 | 41.28 |
| Total distillate | 32.97 | 32.14 | 30.93 |
| (380-700° F.) % | | | |

What is claimed is:

1. A hydrocracking process comprising:
passing a hydrocarbon feed to a single stage hydrocracking unit where the feed is hydrocracked under hydrocracking conditions, and with the catalyst in the hydrocracking unit comprising a base comprised of alumina, an amorphous silica-alumina material, a USY zeolite and a beta zeolite, and with the catalyst comprising citric acid.

2. The process of claim 1, wherein the base comprises 0.1 to 40 wt. % alumina, 20 to 80 wt. % ASA, 0.5 to 60 wt. % USY zeolite, and 0.5 to 40 wt. % beta zeolite.

3. The process of claim 1, wherein the feed comprises a VGO.

4. The process of claim 1, wherein the yield of heavy distillate (boiling in the range of 530-700° F.) is at least 16 wt. % at 55 wt. % conversion.

5. The process of claim 1, wherein the yield of distillates (boiling in the range of 380-700° F.) is at least 32.5 wt. % at 55 wt. % conversion.

6. The process of claim 1, wherein the catalyst comprises the metals nickel (Ni) and tungsten (W) impregnated into the base.

7. The process of claim 6, wherein the catalyst comprises from 2 to 10 wt. % of nickel precursor and from 8 to 40 wt. % of tungsten precursor based on the bulk dry weight of the hydrocracking catalyst.

8. The process of claim 1, wherein the catalyst in the hydrocracking unit is prepared by:
(a) forming an extrudable mass containing the catalyst base,
(b) extruding the mass to form a shaped extrudate,
(c) calcining the mass to form a calcined extrudate,
(d) preparing an impregnation solution containing at least one metal salt, a solvent, and citric acid,
(e) contacting the shaped extrudate with the impregnation solution, and
(f) drying the impregnated extrudate at a temperature sufficient to remove the impregnation solution solvent, to form a dried impregnated extrudate.

9. The process of claim 8, wherein the impregnation solution comprises nickel carbonate.

10. A hydrocracking catalyst comprising a base of alumina, an amorphous silica alumina, a USY zeolite, and a beta zeolite, with the base impregnated with citric add and metals selected from Group 6 and Groups 8 through 10 of the Periodic Table.

11. The hydrocracking catalyst of claim 10, wherein the base comprises 5 to 40 wt. % alumina, 20 to 30 wt. % ASA, 1 to 50 wt. % USY zeolite, and 4 to 20 wt. % beta zeolite, based on the dry weight of the base.

12. The hydrocracking catalyst of claim 10, wherein the catalyst comprises the metals nickel (Ni) and tungsten (W) impregnated into the base.

13. The hydrocracking catalyst of claim 12, wherein the catalyst comprises from 2 to 10 wt. % of nickel precursor and from 8 to 40 wt. % of tungsten precursor based on the dry weight of the hydrocracking catalyst.
